(19) United States
(12) Patent Application Publication
(10) Pub. No.: US 2010/0248820 A1
(43) Pub. Date: Sep. 30, 2010

(54) PARTICLE ARRAY FOR A WAGERING GAME MACHINE

(75) Inventors: Kevin C Johnson, Oak Park, IL (US); Mark Sieka, Frankfort, IL (US); John Walsh, Gurnee, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc.

(21) Appl. No.: 12/742,227

(22) PCT Filed: Nov. 7, 2008
(86) PCT No.: PCT/US08/12544

§ 371 Date: May 11, 2010

Related U.S. Application Data
(60) Provisional application No. 60/986,894, filed on Nov. 9, 2007.

(51) Int. Cl. A63F 9/24; A63F 13/00

(52) U.S. Cl. 463/25; 463/31

(57) ABSTRACT

Systems and methods provide a particle array for a wagering game that may be used to render particles that form an image pattern. The image pattern may be part of a simulated dot matrix marquee. The simulated dot matrix marquee may be associated with a graphical element of a wagering game. The marquee is positioned relative to the graphical element and maintains the same orientation as the graphical element.

### RELATED APPLICATION

This patent application claims the priority benefit of U.S. Provisional Patent Application Ser. No. 60/986,894 filed Nov. 9, 2007 and entitled “PARTICLE ARRAY FOR A WAGERING GAME MACHINE,” the content of which is incorporated herein by reference in its entirety.

### FIELD

The embodiments relate generally to wagering game machines and more particularly to providing a particle array for wagering games presented on wagering game machines.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright© 2007, 2008, WMS Gaming Inc. All Rights Reserved.

### BACKGROUND

Wagering game machine makers continually provide new and entertaining games. One way of increasing entertainment value associated with casino-style wagering games (e.g., video slots, video poker, video black jack, and the like) includes offering a variety of base games and bonus events. However, despite the variety of base games and bonus events, players often lose interest in repetitive wagering game content. In order to maintain player interest, wagering game machine makers frequently update wagering game content with new game themes, game settings, bonus events, game software, and other electronic data. Further, entertainment value may be increased by providing an enhanced visual game play experience.

### BRIEF DESCRIPTION OF THE DRAWINGS

FIG. 1 is a block diagram of an architecture, including a control system, for a wagering game machine according to an example embodiment.

FIG. 2 is a block diagram of a software architecture for a wagering game machine according to an example embodiment.

FIG. 3 is a block diagram of a networked system of wagering game machines and servers according to example embodiments.

FIG. 4 is a flowchart illustrating methods for rendering a display in a wagering game using a particle array according to example embodiments.

FIG. 5A is a block diagram illustrating an example input array according to embodiments of the invention.

FIG. 5B illustrates an example portion of a rendered particle array according to embodiments of the invention.

FIGS. 6A-6D are example screens illustrating displays using particle arrays according to an example embodiment.

FIG. 6E is an example screen image showing text strings that may be presented as an image on a simulated dot matrix marquee.

FIG. 7 is a perspective view of a wagering game machine, according to example embodiments of the invention.

FIG. 8 is a perspective view of a portable wagering game machine according to an example embodiment.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

In general, the system and method embodiments described below provide for the presentation of a wagering game on a wagering game machine where various portions, or various graphical objects or elements within the wagering game, may be presented at different rates of motion through time. Further embodiments provide for replaying a portion of a wagering game from a previous point in time of the presentation of the wagering game. These time control aspects of a wagering may provide for increased excitement and anticipation, provide opportunities for providing input (and thus the sense of more control) and provide opportunities to see details that would not be possible if a standard rate of motion through time were used.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

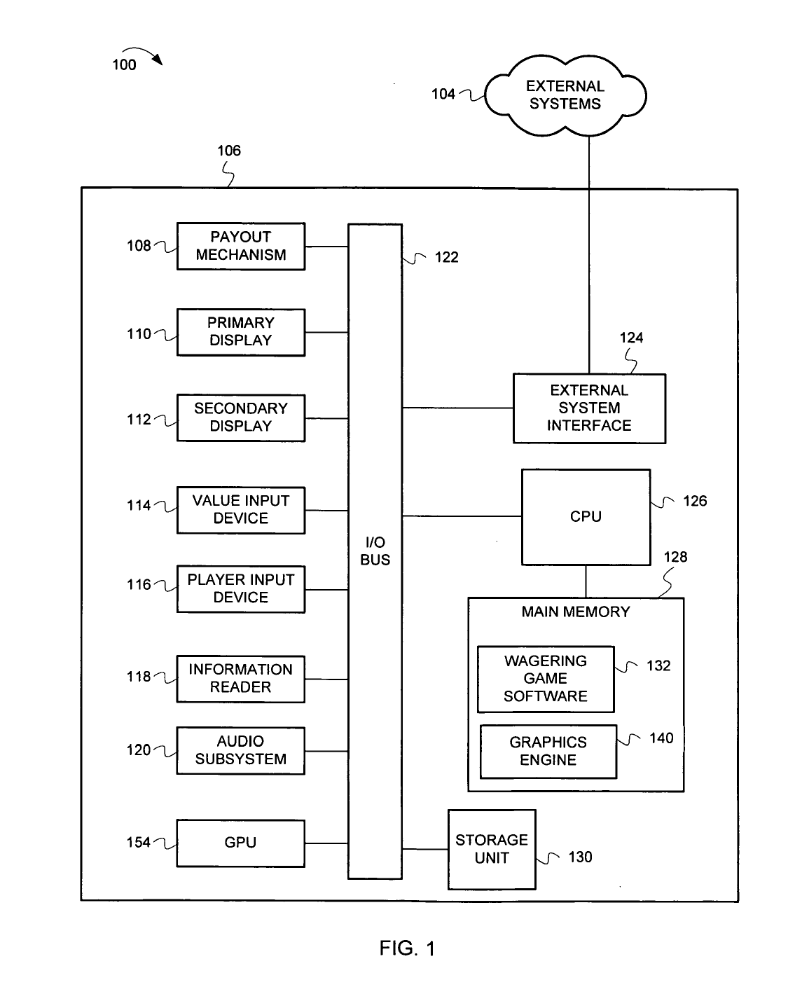

FIG. 1 is a block diagram illustrating a wagering game machine architecture 100, including a control system, according to example embodiments of the invention. As shown in FIG. 1, the wagering game machine 106 includes a central processing unit (processor) 126 connected to main memory 128, which may store wagering game software 132. In one embodiment, the wagering game software can include software associated with presenting wagering games, such as video poker, video black jack, video slots, video lottery, etc., in whole or part. In addition, wagering game software 132 may include bonus rounds, themes, advertising content, attract mode content, pay tables, denomination tables, audio files, video files, operating system files and other software associated with a wagering game or the operation of a wagering game machine.

The processor 126 is also connected to an input/output (I/O) bus 122, which facilitates communication between the wagering game machine's components. The I/O bus 122 may be connected to a payout mechanism 108, graphics processing unit 154, primary display 110, secondary display 112, value input device 114, player input device 116, information reader 118, and/or storage unit 130. The player input device 116 can include the value input device 114 to the extent the player input device 116 is used to place wagers. The I/O bus 122 may also be connected to an external system interface 124, which is connected to external systems 104 (e.g., wagering game networks).

In general, graphics processing unit 154 processes three-dimensional graphics data and may be included as part of primary display 110 and/or secondary display 112. Graphics processing unit 154 includes components that may be used to provide a real-time three-dimensional rendering of a three-dimensional space based on input data. Graphics processing unit 154 may be implemented in software, hardware, or a combination of software and hardware.

In some embodiments, graphics processing unit 154 provides a set of one or more components that provide real-time three dimensional computer graphics for a wagering game application or other software running on a wagering game machine. Graphics processing unit 154 may also be referred to as a game engine. In some embodiments, graphics processing unit 154 provides an underlying set of technologies in an operating system independent manner such that a wagering game may be easily adapted to run on multiple platforms, including various hardware platforms such as stand-alone and portable wagering game machines and various software platforms such as Linux, UNIX, Mac OS X and Microsoft Windows families of operating systems. In some embodiments, graphics processing unit 154 may include various combinations of one or more components such as a rendering engine (“renderer”) for two dimensional or three dimensional graphics, a physics engine and/or components providing collision detection, sound, scripting, animation, artificial intelligence, networking, and scene graphs. A scene graph is generally considered to be an object-oriented representation of a three dimensional game world and is designed for efficient rendering of vast virtual worlds. Thus in various embodiments, a real-time rendering of a three-dimensional model such as a scene graph is provided for a wagering game application or other software operating on a wagering game machine.

The components described above may be implemented in various combinations of software, hardware and/or firmware. Further, while shown as part of a control system 100 for a wagering game machine, graphics processing unit 154 or portions thereof may reside on systems external to the wagering game machine, such as on a game server.

In some embodiments, the components of graphics processing unit 154 may be replaced or extended with more specialized components. For example, in particular embodiments, graphics processing unit 154 may be provided as a series of loosely connected components that can be selectively combined to create a custom graphics engine for a wagering game application.

As noted above, various components may be present or associated with a graphics processing unit 154. For example, a graphics engine 140 may be provided for use with graphics processing unit 154. Various graphics engines are known in the art and may be used in various embodiments of the invention. In some embodiments, the graphics engine comprises a RenderWare graphics engine, available from Criterion Software. Some graphics engines 140 provide real-time 3D rendering capabilities while other components outside of the graphics engine provide other functionality used by wagering games. These types of graphics engines 140 may be referred to as a “rendering engine,” or “3D engine”.

In some embodiments, the graphics processing unit 154 and/or graphics engine 140 may utilize and be designed substantially in accordance with various versions of a graphics API such as Direct3D or OpenGL which provides a software abstraction of a graphics processing unit or video card. Further, in some embodiments, low-level libraries such as DirectX, SDL (Simple DirectMedia Layer), and OpenAL may also be used in presenting a wagering game in order to assist in providing hardware-independent access to other computer hardware such as input devices (mouse, keyboard, and joystick), network cards, and sound cards.

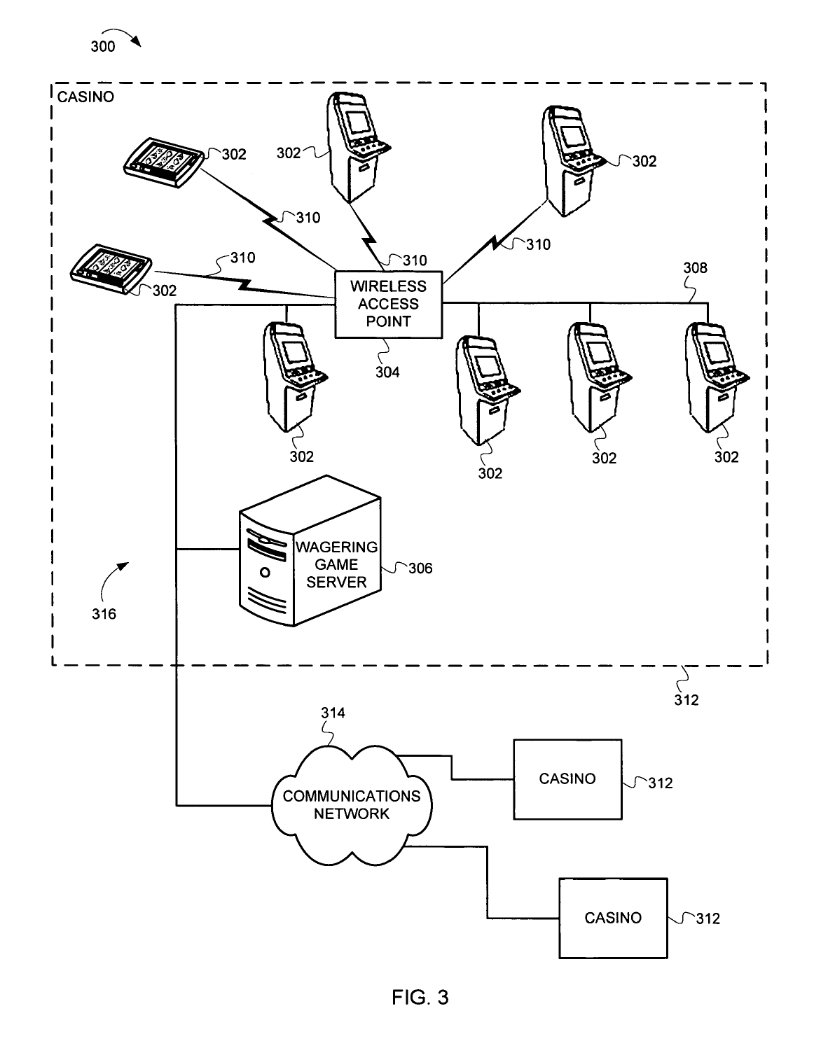

Wagering game software 132 may be loaded from storage unit 130, or it may be loaded from external systems 104 such as servers of other systems on a wagering game network (as illustrated in FIG. 3). In general, wagering game software 132 comprises modules or units that operate to present one or more wagering game upon which monetary value may be wagered. During the course of presenting the wagering games, images composed of graphical objects are displayed on primary display 110 and/or secondary display 112. The graphical objects may represent various wagering game elements such as reels, cards, dice, symbols, animations, etc., and may also represent elements of a bonus round or other ancillary wagering game software component. The graphical objects may include one or more particle arrays arranged in one or more matrices.

Some embodiments of the invention include an audio subsystem 120. Audio subsystem 120 provides audio capabilities to the wagering game machine and may comprise an audio amplifier coupled to speakers or an audio jack, and may further include an audio programming source on a memory such as a CD, DVD, flash memory etc.

In one embodiment, the wagering game machine 106 can include additional peripheral devices and/or more than one of each component shown in FIG. 1. For example, the peripherals may include a bill validator, a printer, a coin hopper, a button panel, or any of the many peripherals now found in wagering game machines or developed in the future. Further, in some embodiments, the wagering game machine 106 can include multiple external system interfaces 124 and multiple processors 126. In one embodiment, any of the components can be integrated or subdivided. Additionally, in one embodiment, the components of the wagering game machine 106 can be interconnected according to any suitable interconnection architecture (e.g., directly connected, hypercube, etc.).

In one embodiment, any of the components of the wagering game machine architecture 100 (e.g., the wagering game presentation unit 132 or portable wagering game management unit) can include hardware, firmware, and/or software for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

In operation, a player may use the portable wagering game machine to activate a play of a wagering game on the machine. Using the available input mechanisms such as value input device 114 or devices coupled through player input device 116, the player may select any variables associated with the wagering game and place his/her wager to purchase a play of the game. In a play of the game, the processor 126 generates at least one random event using a random number generator (RNG) and provides an award to the player for a winning outcome of the random event. Alternatively, the random event may be generated by a remote computer using an RNG or pooling schema and then transmitted to the wagering game machine. The processor 126 operates the displays 110 and 112 to represent the random event(s) and outcome(s) in a visual form that can be understood by the player. In some embodiments, a wagering game segment may be triggered based on certain events. For example, a bonus round may be triggered.

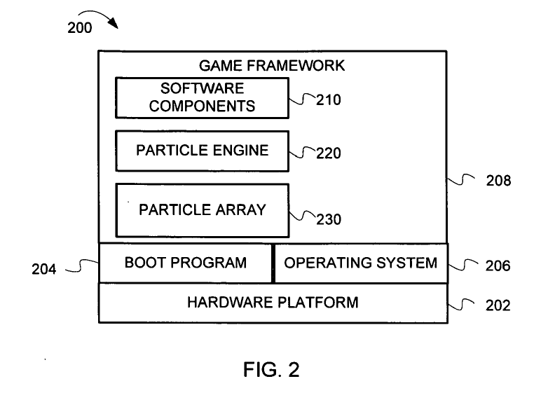

FIG. 2 is a block diagram of a software architecture 200 for a wagering game machine according to an example embodiment. As shown in FIG. 2, the wagering game architecture includes a hardware platform 202, a boot program 204, an operating system 206, and a game framework 208 that includes one or more wagering game software components 210. In various embodiments, the hardware platform 202 may include a thin-client, thick-client, or some intermediate derivation. The hardware platform 202 may also be configured to provide a virtual client. The boot program 204 may include a basic input/output system (BIOS) or other initialization program that works in conjunction with the operating system 206 to provide a software interface to the hardware platform 202. The game framework 208 may include standardized game software components either independent or in combination with specialized or customized game software components that are designed for a particular wagering game. In one example embodiment, the wagering game software components 210 may include software operative in connection with the hardware platform 202 and operating system 206 to present wagering games, such as video poker, video black jack, video slots, video lottery, etc., in whole or part. According to another example embodiment, the software components 210 may include software operative to accept a wager from a player. According to another example embodiment, one or more of the software components 210 may be provided as part of the operating system 206 or other software used in the wagering game system 200 (e.g., libraries, daemons, common services, etc.).

Framework 208 may also include a particle array 230. Particle array 230 comprises a data structure defining the rows and columns of an array of particle objects. A particle object defines properties that determine how particles may be emitted from a particle emitter, and can be used to model amorphous objects, including lights, fire, water and smoke for rendering by a graphics processing unit. The particles may also be used to define surfaces, smooth or otherwise, including the surfaces of rigid and non-rigid objects. Particles may emanate from one or more emitters. In some embodiments, a single emitter may be invoked for on each particle object in the particle array 230, with the emitter generating particles in accordance with the properties defined for each particle in the array 230. In alternative embodiments, emitters are included in particle array 230.

Thus instead of a set of primitive surface elements, e.g., vertices and polygons, a system of particles may be used to define graphical entity. In some embodiments, the particles in a particle array matrix are used to define a simulated dot matrix style marquee that may be attached to other graphical objects or entities. The individual particles in the array are rendered to simulate the pixels or lights in the dot matrix style marquee.

Particles emitted by particle objects in the particle array 230 may have various properties. Examples of such properties used in various embodiments may include various combinations of one or more of the following properties: position, velocity (speed and direction), size, color, transparency, shape (e.g., spherical, rectangular, or streaked spherical), and lifetime, among others. A particle system may be distinguished by several parameters that control the initial position of the particles, such as: the particle system origin in space, angles of rotation that provide orientation, and a generation shape (to define the region around the origin in which new particles are placed). The generation shape may also be used to describe the initial direction of new particles, e.g., for a sphere of radius R, the particles might move away from the origin along radii in all directions.

Particle systems may also include a particle hierarchy, comprising particles that are themselves particle systems. Child particle systems can inherit the properties of their parents.

When particles are used to model an object in an animation sequence, one or more of the following actions may be performed for each frame: generate new particles, assign attributes to each new particle, destroy particles that have existed past their assigned lifetime, and transform remaining particles according to assigned dynamic attributes. For example, in some embodiments, color attributes of a particle may change over time.

Stochastic processes may be used to create and change the appearance of an object defined by a system of particles. Particles may also be generated using stochastic methods. For example, a designer may control the mean number of particles generated per frame, as well as their variance. Alternatively, the designer may decide to generate a certain number of particles per screen area, making it easier to control the level of detail. Particles can also interact with other particles or objects, including conventionally modeled primitives.

In addition, the level of detail can be easily adjusted. For example, distant particles can be modeled with low detail (e.g., as a small system of particles), and close particles may be modeled with high detail (e.g., as a large system of particles).

In some embodiments, a particle engine 220 may be used to assist in the rendering of particles in particle array 230. The particle engine 220 may be a “plug-in” component of a graphics engine. For example, in some embodiments, a particle plug-in for the RenderWare graphics engine is used to render particles.

While FIGS. 1 and 2 describe example embodiments of a wagering game machine hardware and software architecture, FIG. 3 shows how a plurality of wagering game machines can be connected in a wagering game network.

FIG. 3 is a block diagram illustrating a wagering game network 300, according to example embodiments of the invention. As shown in FIG. 3, the wagering game network 300 includes a plurality of casinos 312 connected to a communications network 314.

Each of the plurality of casinos 312 includes a local area network 316, which may include a wireless access point 304, wagering game machines 302, and a wagering game server 306 that can serve wagering games over the local area network 316. As such, the local area network 316 includes wireless communication links 310 and wired communication links 308. The wired and wireless communication links can employ any suitable connection technology, such as Bluetooth, 802.11, Ethernet, public switched telephone networks, SONET, etc. In one embodiment, the wagering game server 306 can serve wagering games and/or distribute content to devices located in other casinos 312 or at other locations on the communications network 314.

The wagering game machines 302 and wagering game server 306 can include hardware and machine-readable media including instructions for performing the operations described herein.

The wagering game machines 302 described herein can take any suitable form, such as floor standing models, handheld mobile units, bartop models, workstation-type console models, etc. Further, the wagering game machines 302 can be primarily dedicated for use in conducting wagering games, or can include non-dedicated devices, such as mobile phones, personal digital assistants, personal computers, etc. In one embodiment, the wagering game network 300 can include other network devices, such as accounting servers, wide area progressive servers, player tracking servers, and/or other devices suitable for use in connection with embodiments of the invention.

In various embodiments, wagering game machines 302 and wagering game servers 306 work together such that a wagering game machine 302 may be operated as a thin, thick, or intermediate client. For example, one or more elements of game play may be controlled by the wagering game machine 302 (client) or the wagering game server 306 (server). Game play elements may include executable game code, lookup tables, configuration files, game outcome, audio or visual representations of the game, game assets or the like. In a thin-client example, the wagering game server 306 may perform functions such as determining game outcome or managing assets, while the wagering game machine 302 may be used merely to present the graphical representation of such outcome or asset modification to the user (e.g., player). In a thick-client example, game outcome may be determined locally (e.g., at the wagering game machine 302) and then communicated to the wagering game server 306 for recording or managing a player's account.

Similarly, functionality not directly related to game play may be controlled by the wagering game machine 302 (client) or the wagering game server 306 (server) in embodiments. For example, power conservation controls that manage a display screen's light intensity may be managed centrally (e.g., by the wagering game server 306) or locally (e.g., by the wagering game machine 302). Other functionality not directly related to game play may include presentation of advertising, software or firmware updates, system quality or security checks, etc.

### Example Wireless Environment

In some embodiments, the wireless access point 304 can be part of a communication station, such as wireless local area network (WLAN) communication station including a Wireless Fidelity (WiFi) communication station, or a WLAN access point (AP). In these embodiments, the wagering game machines 302 can be part of a mobile station, such as WLAN mobile station or a WiFi mobile station.

In some other embodiments, the wireless access point 304 can be part of a broadband wireless access (BWA) network communication station, such as a Worldwide Interoperability for Microwave Access (WiMax) communication station, as the wireless access point 304 can be part of almost any wireless communication device. In these embodiments, the wagering game machines 302 can be part of a BWA network communication station, such as a WiMax communication station.

In some embodiments, any of the wagering game machines 302 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

In some embodiments, the wireless access point 304 and the wagering game machines 302 can communicate RF signals in accordance with specific communication standards, such as the Institute of Electrical and Electronics Engineers (IEEE) standards including IEEE 802.11(a), 802.11(b), 802.11(g), 802.11(h) and/or 802.11(n) standards and/or proposed specifications for wireless local area networks, but they can also be suitable to transmit and/or receive communications in accordance with other techniques and standards. In some BWA network embodiments, the wireless access point 304 and the wagering game machines 302 can communicate RF signals in accordance with the IEEE 802.16-2004 and the IEEE 802.16(e) standards for wireless metropolitan area networks (WMANs) including variations and evolutions thereof. However, they can also be suitable to transmit and/or receive communications in accordance with other techniques and standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” Can 2005 and related amendments/versions.

In other embodiments, the wireless access point 304 and the wagering game machines 302 can communicate in accordance with a short-range wireless standard, such as the Bluetooth™ short-range digital communication protocol.

It will be appreciated from the above that various components of a wagering game architecture and/or their functionality may be distributed in various manners. For example, all of the components and functionality may reside in a wagering game machine, or various portions may reside in part on a wagering game machine and in part on a server or other network attached device. The scope of the inventive subject matter is meant to include all of these environments.

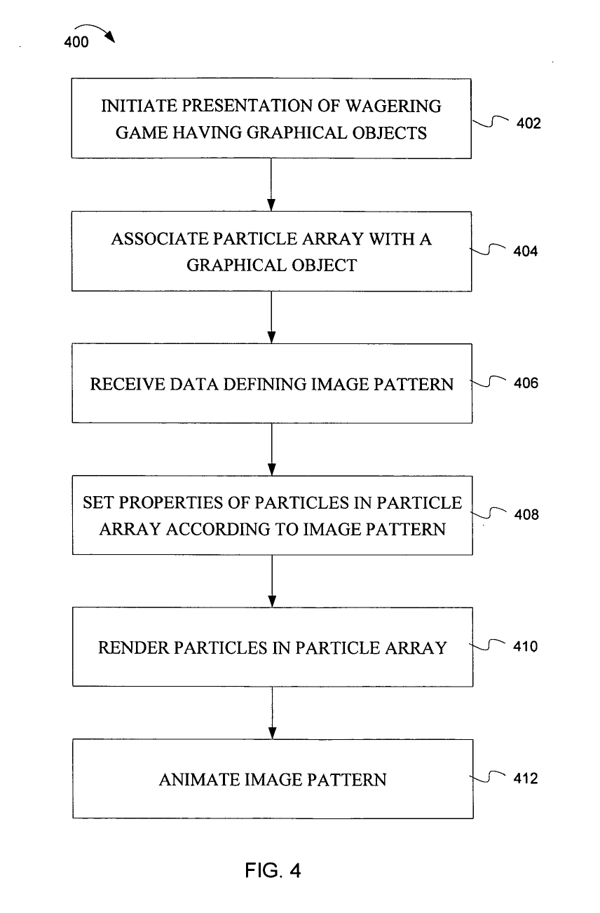

FIG. 4 is a flowchart illustrating a method 400 for rendering a display in a wagering game using a particle array according to example embodiments. The methods to be performed by an operating environment such as control system 100 and network system 300 constitute computer programs made up of computer-executable instructions. Describing the methods by reference to a flowchart enables one skilled in the art to develop such programs including such instructions to carry out the method on suitable processors for gaming machines (the processor or processors of the computer executing the instructions from computer-readable media). The methods illustrated in FIG. 4 are inclusive of acts that may be taken by an operating environment executing an exemplary embodiment of the invention.

In some embodiments, method 400 begins at block 402 by initiating the presentation of a wagering game upon which monetary value may be wagered. The wagering game may be any type of wagering game such as video versions of a slots, poker, keno, bingo, pachinko, craps or any other type of wagering game. The wagering game has graphical objects that define elements of the display for the wagering game. For example, graphical objects may be used to define and render reels, symbols, tokens, characters, text, fields, backgrounds or any other object that is displayed as part of a wagering game or a bonus game of a wagering game.

At block 404, a particle array is associated with a graphical object. Once associated, the particles in the particle array are rendered such that the particles have the same orientation relative to the display as the graphical object. Further, the position of the particles in the array move as the graphical object moves. In some embodiments, a position of a corner particle of the array is associated with a position on the graphical object, and the position of the remaining particles in the array may be determined relative to the corner particle. Also, particles in particle array may be positioned such that they are mapped onto the surface of a graphical object. Thus if the graphical object has a concave, convex or other shape, the particles in the particle array will be rendered such that they also have the shape of the object they are associated with.

At block 406, the system receives data indicating an image pattern that is to be displayed using particles in a particle array. In some embodiments, the data is used to update properties of particle objects in the particle array. In alternative embodiments, the data comprises an input array that defines an image pattern. The values of the input array determine the properties of the particles in the particle array. In some embodiments, the input array may have the same number of rows and columns as the particle array. Particular values of the input array determine the properties of the particle object at that corresponding position in the particle array. Thus values in the input array may determine whether particles representing a background or image pattern are rendered. For example, one value may indicate that particles representing a background “dot” of the simulated dot matrix marquee are to be rendered, while another value may be used to indicate that particles representing an image pattern “dot” are to be rendered.

In further alternative embodiments, the input data may comprise a text string defining text that is to be displayed on the simulated dot matrix marquee. The text string may be converted into a dot matrix form and appropriate properties in the particle array may be set such that when rendered, the particles in the particle array display a dot matrix simulation of the input text string.

At block 408, the properties of particle objects in the particle array are set according to the input data received at block 408. As noted above, properties such as color and/or intensity may be used to differentiate particles that are emitted as part of the background versus particles that are emitted that are part of the image data.

At block 410, a display image is rendered. The display image includes graphical objects for the wagering game and particles rendered as defined by the particle properties in the particle array.

At block 412, the simulated dot matrix marquee may be animated using a variety of techniques. In some embodiments, the image on the simulated dot matrix marquee may be scrolled across the simulated marquee. For example, the input data may be shifted and resupplied to the system to make the image appear to scroll horizontally or vertically (or both) in subsequent renderings.

Alternatively, the particle objects in the particle array itself may be shifted such to make the image appear to scroll. Other forms of animation are possible. For example, particles representing an image on the marquee may appear to be initially positioned at random position in the simulated dot matrix marquee, and then repositioned in subsequent renderings such that they move to gradually form an image in the simulated dot matrix marquee. Alternatively, the particles may be positioned to initially form a first image in the simulated dot matrix marquee, and then moved in subsequent renderings such that first image appears to morph into a second image. Various other animations are possible and within the scope of the inventive subject matter.

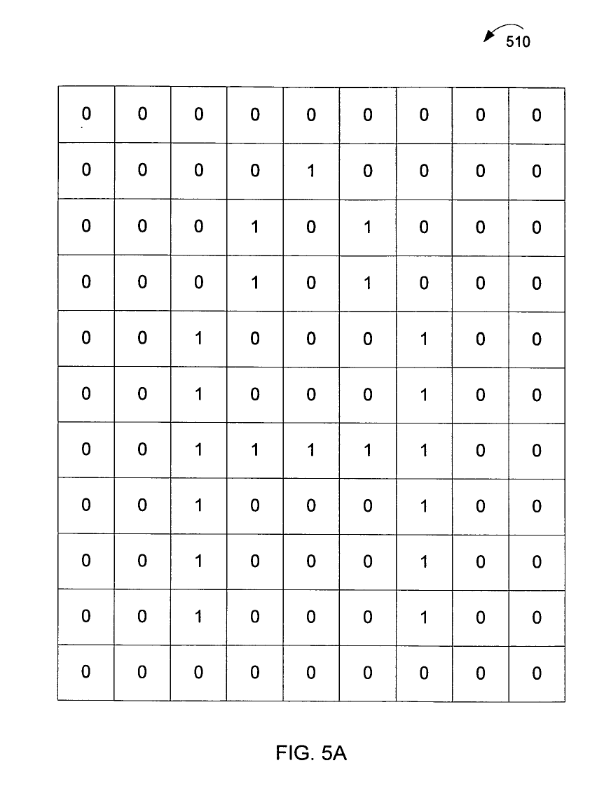

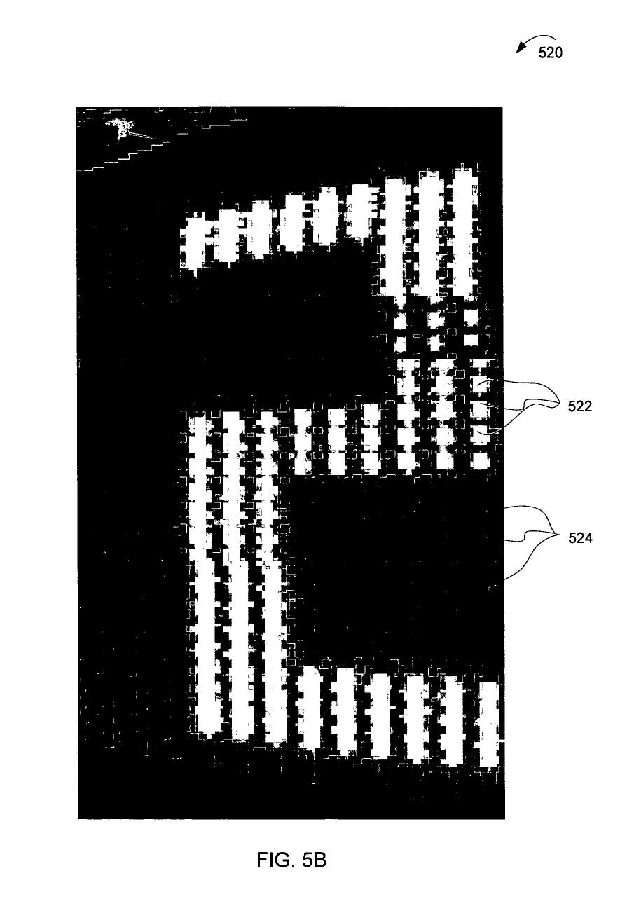

FIGS. 5A and 5B are diagrams illustrating an example input array and an example rendered particle array. In FIG. 5A, an example of a portion 510 of an input array is provided that represents a character “A” in an image pattern. In the example shown, a value of 0 is used to indicate that particles representing a background “dot” of a simulated dot matrix marquee are to be emitted, while a value of 1 is used to indicate that particles representing a “dot” that is part of an image pattern of a simulated dot matrix marquee are to emitted. Those of skill in the art will appreciate that alternative values could be used indicate background and image patterns, and further, an image pattern may use more than one value such that the image pattern rendered as a simulated dot matrix marquee may be composed of particles having different properties. For example, a multi-colored image pattern may be defined, or an inverse image may be defined.

FIG. 5B illustrates an example portion of a rendered particle array 520. In the example shown a character “2” has been rendered. The character appears slightly skewed because it has been rendered according to the position and orientation of an associated underlying graphical object. As can be seen in FIG. 5B, an example of a simulated image dot of a dot matrix marquee that is rendered using particles that are emitted is shown at position 522, while an example of a simulated background dot of the dot matrix marquee that has been rendered using particles that are emitted is shown at position 524.

### Example Wagering Game

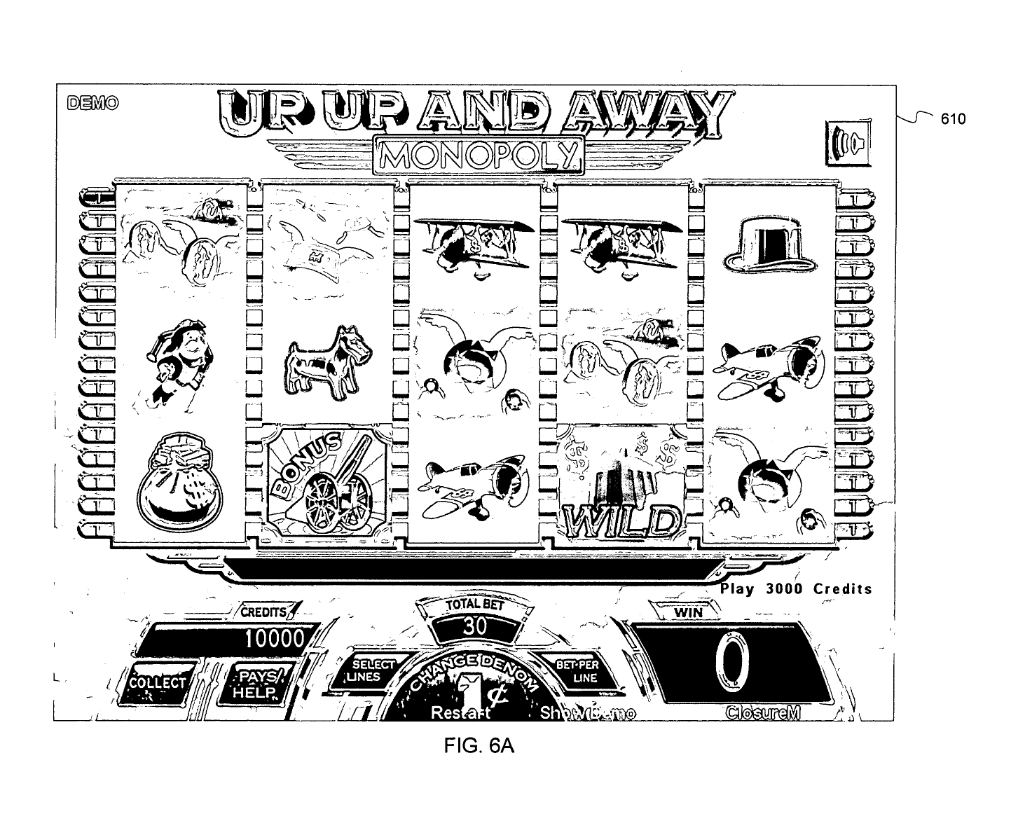

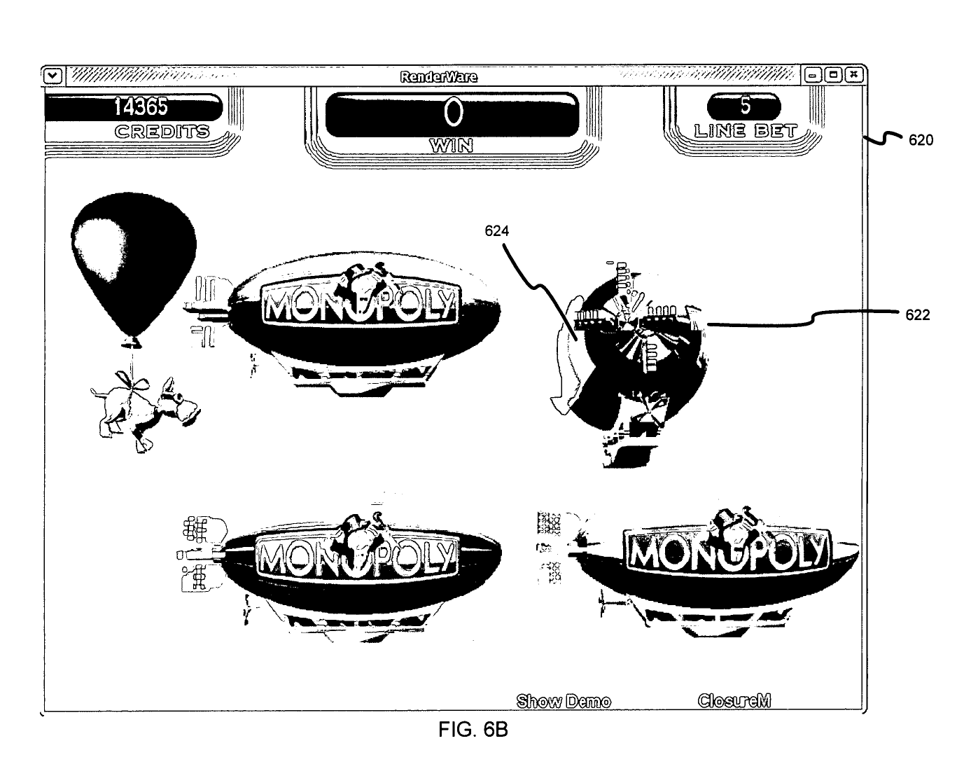

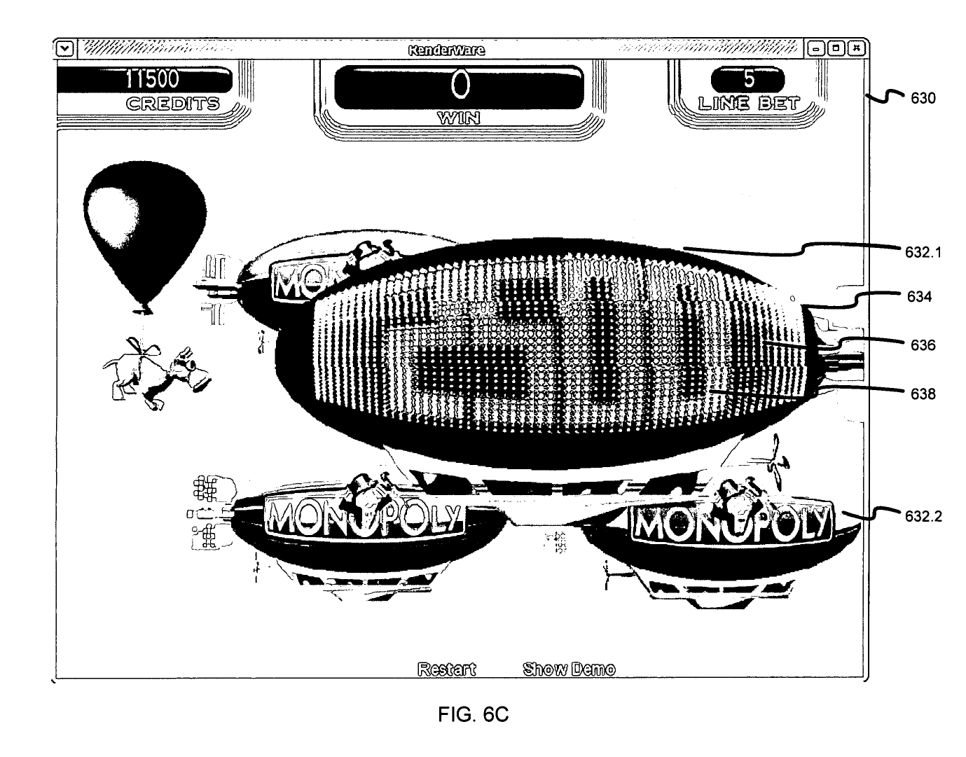

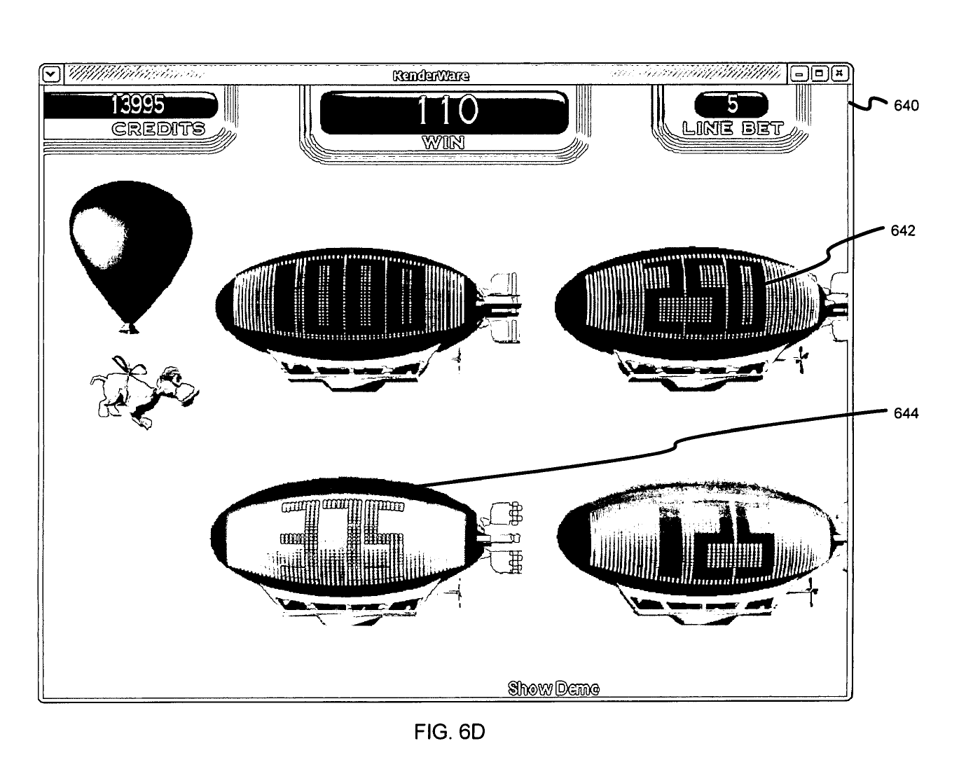

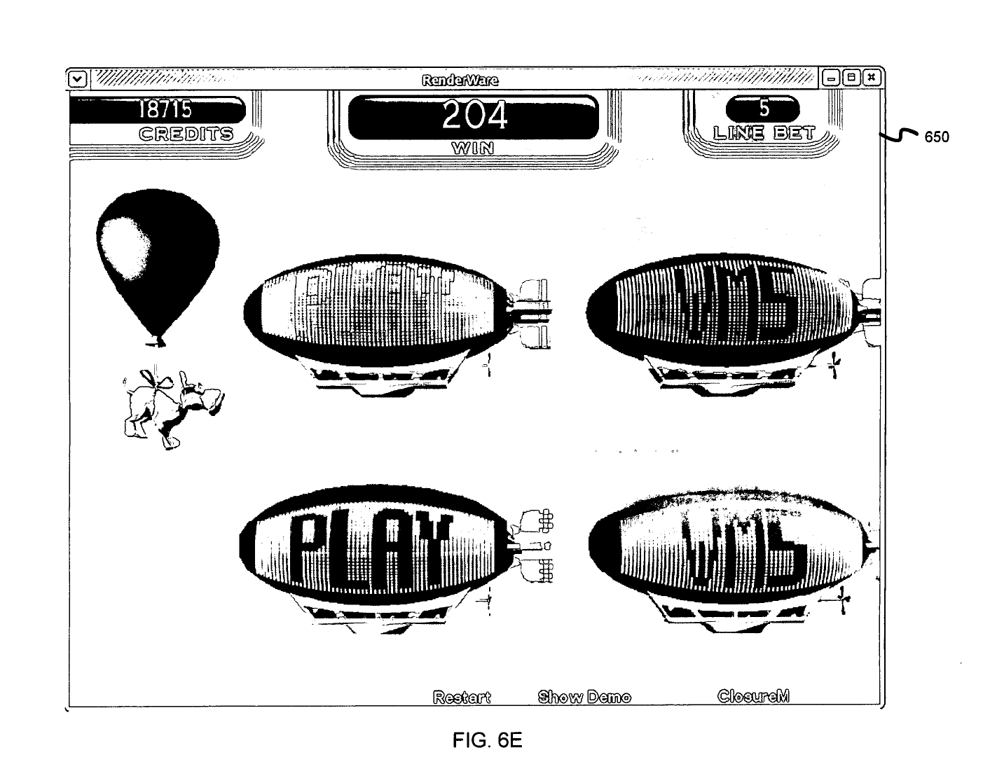

FIGS. 6A-6D are example screen images for a wagering game utilizing a particle array according to an embodiment of the invention. The screen images represent portions of a base and bonus games based on the Hasbro Inc. Monopoly® board game, and is available as the “Monopoly Up Up and Away” wagering game available from WMS Gaming Inc. of Chicago, Ill. Various graphical objects represent elements of the board game, such as tokens, properties shown on the game board, houses, hotels, Chance cards, Community Chest cards, etc.

FIG. 6A is an example screen image 610 for a base game of the wagering game. As shown in FIG. 6A, a set of reels in includes various symbols where the arrangement of the reels represents the outcome of the wagering game, and further may determine whether a bonus game of the wagering game is started. Some of the symbols are based on elements of the Monopoly game, including hotels, tokens, characters etc. During the play of the wagering game, various bonus rounds may be triggered. In one embodiment, a set of hotels appears around a monopoly board. Further, a set of trampolines appears on the display. A player picks trampolines, and earns the bonus that appears under the trampoline. In some embodiments, if a hotel appears, then a “Mr. Monopoly” character jumps to one of the hotels and a bonus game is initiated. In some embodiments, a blimp bonus game may be initiated when the “Mr. Monopoly” character jumps to a particular hotel.

In the blimp bonus game, a player selects one of a plurality of blimps (in some embodiments, one of four blimps may be selected). Upon selection, the blimp turns and reveals a credit amount on its side.

FIG. 6B is an example screen image 620 for a blimp bonus game according to embodiments of the invention. In the example shown in FIG. 6B, four blimps are displayed. In the example shown, blimp 622 has been selected by a player and is starting to turn. The particles forming the simulated dot matrix marquee 624 that reveal the bonus credit amount are rendered such that they have the same orientation as the blimp the marquee is associated with (blimp 622). Thus simulated dot matrix marquee 624 turns and moves in the same manner as its associated blimp 622.

FIG. 6C is an example screen image 630 for a fully revealed blimp in a blimp bonus game according to embodiments of the invention. As shown in FIG. 6B, four blimps 632 are displayed. The selected blimp 632.1 has completed its turn to reveal a credit amount in a simulated dot matrix marquee 634 rendered using a particle array according to embodiments of the invention. In the simulated dot matrix marquee, some particles represent a background dot in a background area 636, while other particles are emitted and rendered that represent a dot a portion 638 of an image representing the credit amount.

FIG. 6D is an example screen image 640 for the blimp bonus game that may appear after the credit amount associated with a selected blimp has been revealed. The credit amounts for all of the blimps are revealed so that the player may know what bonus amounts could have been selected. In screen 640, all the blimps have credit amounts displayed as a simulated dot matrix marquee rendered using a particle array. In the example shown, a selected blimp 644 has an image in the simulated dot matrix marquee where the particle properties have a first color, whereas non-selected blimps (e.g., blimp 642) have a simulated dot matrix marquee where particles that are part of the image are rendered in a second color. In some embodiments, the second color is the same as or similar to the color of the underlying blimp. In alternative embodiments, the second color is an inverse of the first color. After the credit values associated with the blimps has been revealed, the blimps may return to their original position in preparation for a new round of the bonus game. As the blimps return to their original position, the dot matrix marquee associated with the blimp moves and turns along with the blimp.

FIG. 6E is an example screen image 650 showing that various text strings may be presented as an image on a simulated dot matrix marquee.

### Example Wagering Game Machine

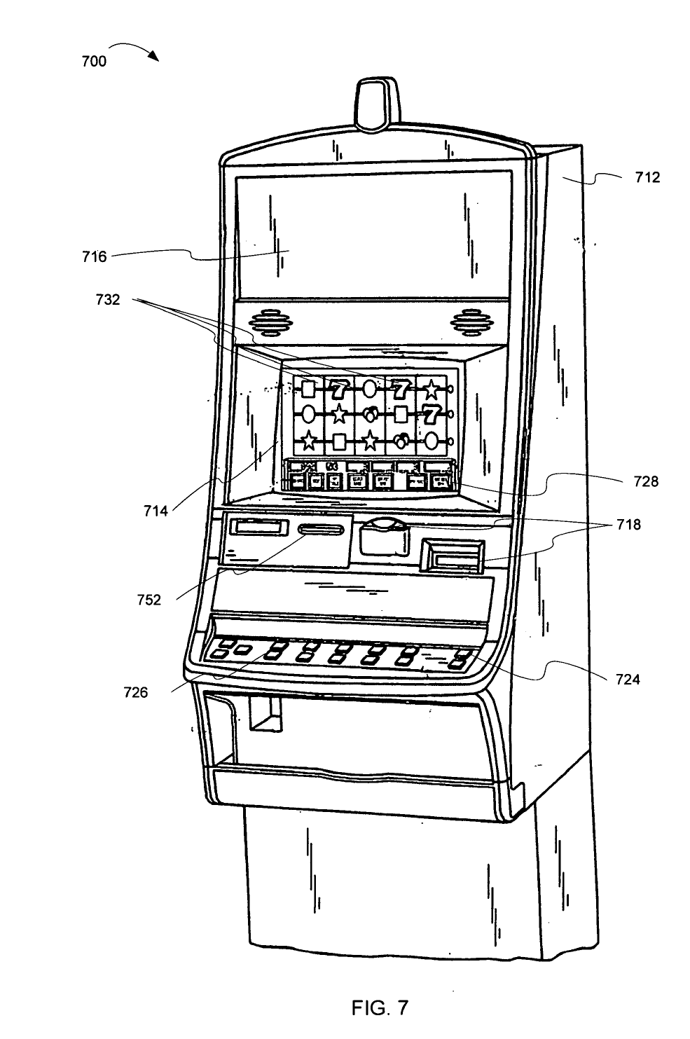

FIG. 7 is a perspective view of a wagering game machine, according to example embodiments of the invention. Referring to FIG. 7, a wagering game machine 700 is used in gaming establishments, such as casinos. According to embodiments, the wagering game machine 700 can be any type of wagering game machine and can have varying structures and methods of operation. For example, the wagering game machine 700 can be an electromechanical wagering game machine configured to play mechanical slots, or it can be an electronic wagering game machine configured to play video casino games, such as blackjack, slots, keno, poker, blackjack, roulette, etc.

The wagering game machine 700 comprises a housing 712 and includes input devices, including value input devices 718 and a player input device 724. For output, the wagering game machine 700 includes a primary display 714 for displaying information about a basic wagering game. The primary display 714 can also display information about a bonus wagering game and a progressive wagering game. The wagering game machine 700 also includes a secondary display 716 for displaying wagering game events, wagering game outcomes, and/or signage information. While some components of the wagering game machine 700 are described herein, numerous other elements can exist and can be used in any number or combination to create varying forms of the wagering game machine 700.

The value input devices 718 can take any suitable form and can be located on the front of the housing 712. The value input devices 718 can receive currency and/or credits inserted by a player. The value input devices 718 can include coin acceptors for receiving coin currency and bill acceptors for receiving paper currency. Furthermore, the value input devices 718 can include ticket readers or barcode scanners for reading information stored on vouchers, cards, or other tangible portable storage devices. The vouchers or cards can authorize access to central accounts, which can transfer money to the wagering game machine 700.

The player input device 724 comprises a plurality of push buttons on a button panel 726 for operating the wagering game machine 700. In addition, or alternatively, the player input device 724 can comprise a touch screen 728 mounted over the primary display 714 and/or secondary display 716.

The various components of the wagering game machine 700 can be connected directly to, or contained within, the housing 712. Alternatively, some of the wagering game machine's components can be located outside of the housing 712, while being communicatively coupled with the wagering game machine 700 using any suitable wired or wireless communication technology.

The operation of the basic wagering game can be displayed to the player on the primary display 714. The primary display 714 can also display a bonus game associated with the basic wagering game. The primary display 714 can include a cathode ray tube (CRT), a high resolution liquid crystal display (LCD), a plasma display, light emitting diodes (LEDs), or any other type of display suitable for use in the wagering game machine 700. Alternatively, the primary display 714 can include a number of mechanical reels to display the outcome. In FIG. 7, the wagering game machine 700 is an “upright” version in which the primary display 714 is oriented vertically relative to the player. Alternatively, the wagering game machine can be a “slant-top” version in which the primary display 714 is slanted at about a thirty-degree angle toward the player of the wagering game machine 700. In yet another embodiment, the wagering game machine 700 can exhibit any suitable form factor, such as a free standing model, bartop model, mobile handheld model, or workstation console model. Further, in some embodiments, the wagering game machine 700 may be include an attached chair assembly, and may include audio speakers designed to provide an enhanced audio environment. For example, a “surround sound” system may be included as part of the wagering game machine and may be integrated with the attached chair.

A player begins playing a basic wagering game by making a wager via the value input device 718. The player can initiate play by using the player input device's buttons or touch screen 728. The basic game can include arranging a plurality of symbols along a payline 732, which indicates one or more outcomes of the basic game. Such outcomes can be randomly selected in response to player input. At least one of the outcomes, which can include any variation or combination of symbols, can trigger a bonus game.

In some embodiments, the wagering game machine 700 can also include an information reader 752, which can include a card reader, ticket reader, bar code scanner, RFID transceiver, or computer readable storage medium interface. In some embodiments, the information reader 752 can be used to award complimentary services, restore game assets, track player habits, etc.

### Example Portable Wagering Game Machine

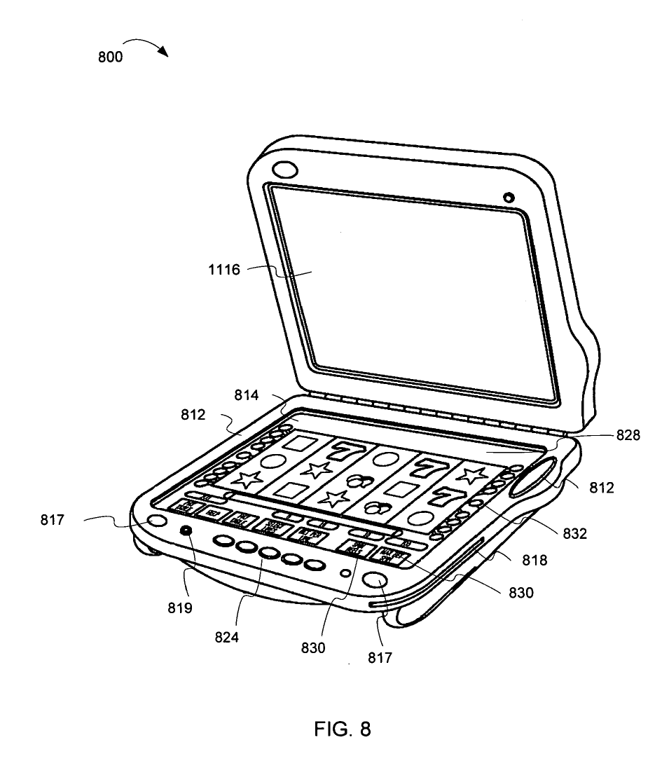

FIG. 8 shows an example embodiment of a portable wagering game machine 800. The portable wagering game machine 800 can include any suitable electronic handheld or mobile device configured to play a video casino game such as blackjack, slots, keno, poker, blackjack, and roulette. The wagering game machine 800 comprises a housing 812 and includes input devices, including a value input device 818 and a player input device 824. For output, the wagering game machine 800 includes a primary display 814, and may include a secondary display 816, one or more speakers 817, one or more player-accessible ports 819 (e.g., an audio output jack for headphones, a video headset jack, etc.), and other conventional I/O devices and ports, which may or may not be player-accessible. In the embodiment depicted in FIG. 8, the wagering game machine 800 includes a secondary display 816 that is rotatable relative to the primary display 814. The optional secondary display 816 can be fixed, movable, and/or detachable/attachable relative to the primary display 814. Either the primary display 814 and/or secondary display 816 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 818 can comprise, for example, a slot located on the front, side, or top of the casing 812 configured to receive credit from a stored-value card (e.g., casino card, smart card, debit card, credit card, etc.) inserted by a player. The player-accessible value input device 818 can also comprise a sensor (e.g., an RF sensor) configured to sense a signal (e.g., an RF signal) output by a transmitter (e.g., an RF transmitter) carried by a player. The player-accessible value input device 818 can also or alternatively include a ticket reader, or barcode scanner, for reading information stored on a credit ticket, a card, or other tangible portable credit or funds storage device. The credit ticket or card can also authorize access to a central account, which can transfer monetary value to the wagering game machine 800.

Still other player-accessible value input devices 818 can require the use of touch keys 830 on the touch-screen display (e.g., primary display 814 and/or secondary display 816) or player input devices 824. Upon entry of player identification information and, preferably, secondary authorization information (e.g., a password, PIN number, stored value card number, predefined key sequences, etc.), the player can be permitted to access a player's account. As one potential optional security feature, the wagering game machine 800 can be configured to permit a player to only access an account the player has specifically set up for the wagering game machine 800. Other conventional security features can also be utilized to, for example, prevent unauthorized access to a player's account, to minimize an impact of any unauthorized access to a player's account, or to prevent unauthorized access to any personal information or funds temporarily stored on the wagering game machine 800.

The player-accessible value input device 818 can itself comprise or utilize a biometric player information reader which permits the player to access available funds on a player's account, either alone or in combination with another of the aforementioned player-accessible value input devices 818. In an embodiment wherein the player-accessible value input device 818 comprises a biometric player information reader, transactions such as an input of value to the wagering game machine 810, a transfer of value from one player account or source to an account associated with the wagering game machine 800, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 818 comprising a biometric player information reader can require a confirmatory entry from another biometric player information reader 852, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with an authentication fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 818 can be provided remotely from the wagering game machine 810.

The player input device 824 may include a plurality of push buttons on a button panel for operating the wagering game machine 800. In addition, or alternatively, the player input device 824 can comprise a touch screen mounted to the primary display 814 and/or secondary display 816. In one aspect, the touch screen is matched to a display screen having one or more selectable touch keys 830 selectable by a user's touching of the associated area of the screen using a finger or a tool, such as a stylus pointer. A player enables a desired function either by touching the touch screen at an appropriate touch key 830 or by pressing an appropriate push button on the button panel. The touch keys 830 can be used to implement the same functions as push buttons. Alternatively, the push buttons 826 can provide inputs for one aspect of the operating the game, while the touch keys 830 can allow for input needed for another aspect of the game. The various components of the wagering game machine 800 can be connected directly to, or contained within, the casing 812, as seen in FIG. 8, or can be located outside the casing 812 and connected to the casing 812 via a variety of wired (tethered) or wireless connection methods. Thus, the wagering game machine 800 can comprise a single unit or a plurality of interconnected (e.g., wireless connections) parts which can be arranged to suit a player's preferences.

The operation of the basic wagering game on the wagering game machine 800 is displayed to the player on the primary display 814. The primary display 814 can also display a bonus game associated with the basic wagering game. The primary display 814 preferably takes the form of a high resolution LCD, a plasma display, an LED, or any other type of display suitable for use in the wagering game machine 800. The size of the primary display 814 can vary from, for example, about a 2-3″ display to a 15″ or 17″ display. In at least some embodiments, the primary display 814 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 814 and/or secondary display 816 can have a 16:9 aspect ratio or other aspect ratio (e.g., 4:3). The primary display 814 and/or secondary display 816 can also each have different resolutions, different color schemes, and different aspect ratios.

A player typically begins play of the basic wagering game on the wagering game machine 800 by making a wager (e.g., via the value input device 818 or an assignment of credits stored on the portable wagering game machine 800 via the touch screen keys 830, player input device 824, or buttons 826) on the wagering game machine 800. In some embodiments, the basic game can comprise a plurality of symbols arranged in an array, and includes at least one payline 832 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 818 of the wagering game machine 800 can double as a player information reader 852 that allows for identification of a player by reading a card with information indicating the player's identity (e.g., reading a player's credit card, player ID card, smart card, etc.). The player information reader 852 can alternatively or also comprise a bar code scanner, RFID transceiver or computer readable storage medium interface. In one embodiment, the player information reader 852 comprises a biometric sensing device.

In some embodiments, a portable wagering game machine 800 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

### CONCLUSION

Systems and methods for presenting a wagering game in which a portion or elements of the wagering game are rendered using a particle array have been described. The particle array of the various embodiments may provide various advantages over other rendering techniques. For example, a particle array may be a more efficient way of dealing with the thousands of elements (tiny bit maps) that make up an array of lights in a simulated dot matrix marquee. Alternative mechanisms such as texture mapping can be difficult to manage with the use of a simple texture map, and may impact the frame rate at which images may be rendered. Further, in some embodiments, a particle array allows the use of one tiny texture map for all of the particles in the array.

A particle array provides the ability to arrange the particles in a specific configuration. For example, in the “Monopoly: Up Up and Away” embodiment described above, the particle array is arranged to follow the contours of the blimp surfaces. A particle array also provides the ability to control the number of rows and columns needed for the display of text. A simple bit map generally does not provide this visual effect. By containing the particle emitters into a array of rows and columns, the density of the display and the size of the digits can be specified and controlled.

Additionally, the particle array of various embodiments provides the ability to take advantage of transparency and blending modes available through the use of particle effects. A simple texture map typically does not provide the ability to use additive blending to simulate self illumination and glow effects.

Further, the particle array of various embodiments provides the ability to control the life and of each element and its position. This provides the ability to offset the digits or characters that appear on the matrix and look like they are scrolling across the display. A simple bit map typically cannot simulate that effect correctly.

In some embodiments, the use of a particle array provides the ability to create shapes and letters from the particles in real time. It is not necessary to create dedicated textures or animations. The image data can be generated from the numbers or letters in a string value.

Moreover, the particle array of various embodiments provides the ability to control the intensity and color in real time without additional art.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. A method for execution by one or more processors, the method comprising:
presenting a wagering game upon which monetary value may be wagered, the wagering game including one or more graphical objects;
associating a particle array with a graphical object of the one or more graphical objects, the particle array comprising a plurality of particle objects, the particle objects having one or more properties defining particles emitted in accordance with the one or more properties;
receiving data defining an image pattern; and
setting the one or more properties for a plurality of particles in the particle array according to the image pattern wherein the image pattern is displayed when the plurality of particles are rendered.

2. The method of claim 1, wherein an orientation and position of the particle matrix array is related to an orientation and position of the graphical object.

3. The method of claim 2, wherein the positions of the plurality of particles in the particle array are mapped to positions on the surface of the graphical object.

4. The method of claim 1, wherein setting one or more properties includes setting color properties such that particles included in image pattern are set to a first color and wherein particles not included in the image pattern are set to a second color.

5. The method of claim 1, wherein setting one or more properties includes setting intensity properties such that particles included in image pattern are set to a first intensity and wherein particles not included in the image pattern are set to a second intensity.

6. The method of claim 1, wherein the image pattern comprises an input array indicating the particles in the particle array that are included in the image pattern.

7. The method of claim 1, wherein the image pattern comprises an alphanumeric text string.

8. The method of claim 1, further comprising animating the image pattern in the particle array.

9. The method of claim 7, wherein animating the image pattern includes scrolling the image pattern

10. The method of claim 9, wherein scrolling the image pattern includes receiving data defining a scrolled image pattern.

11. An apparatus comprising:
at least one processor and a memory, the processor and the memory operable to present a wagering game upon which monetary value may be wagered;
at least one graphical object in the memory, the graphical object defining a game element of the wagering game, the graphical object having a position and an orientation; and
at least one particle array in the memory, the particle array comprising a plurality of objects, the particle objects having one or more properties defining particles emitted in accordance with the one or more properties, the particle array being associated with the at least one graphical object and having the same position and orientation as the graphical object.

12. The apparatus of claim 11, wherein the particle array is arranged in rows and columns, and wherein at least one of the one or more properties of each particle object in a subset of particle objects in the particle array is set such that the particles emitted from the particle object during a rendering operation form an image specified input data.

13. The apparatus of claim 12, wherein the one or more properties include a color property.

14. The apparatus of claim 12, wherein the particle array is rendered to display a simulated dot matrix.

15. A machine readable medium having processor executable instructions stored thereon for causing one or more processors to execute a method, the method comprising:
presenting a wagering game upon which monetary value may be wagered, the wagering game including one or more graphical objects;
associating a particle array with a graphical object of the one or more graphical objects, the particle array comprising a plurality of particle objects, the particle objects having one or more properties defining particles emitted in accordance with the one or more properties;
receiving data defining an image pattern; and
setting one or more properties for a plurality of particles in the particle array according to the image pattern wherein the image pattern is displayed when the plurality of particles are rendered.

16. The machine readable medium of claim 15, wherein an orientation and position of the particle array is related to an orientation and position of the graphical object.

17. The machine readable medium of claim 16, wherein the positions of the plurality of particles in the particle array are associated with positions on the surface of the graphical object such that the plurality of particles in the particle array have the same shape as the surface of the graphical object.

18. The machine readable medium of claim 15, wherein setting one or more properties includes setting color properties such that particles included in image pattern are set to a first color and wherein particles not included in the image pattern are set to a second color.

19. The machine readable medium of claim 15, wherein setting one or more properties includes setting intensity properties such that particles included in image pattern are set to a first intensity and wherein particles not included in the image pattern are set to a second intensity.

20. The machine readable medium of claim 15, wherein the image pattern comprises an input array indicating the particles in the particle array that are included in the image pattern.

21. The machine readable medium of claim 15, wherein the image pattern comprises an alphanumeric text string.

22. The machine readable medium of claim 15, wherein the method further comprises animating the image pattern in the particle array.

23. The machine readable medium of claim 22, wherein animating the image pattern includes scrolling the image pattern.

24. The machine readable medium of claim 23, wherein scrolling the image pattern includes receiving data defining a scrolled image pattern.
